(19) United States
(12) Patent Application Publication
(10) Pub. No.: US 2006/0271677 A1
(43) Pub. Date: Nov. 30, 2006

(54) Policy based data path management, asset management, and monitoring

(76) Inventor: Christina Woody Mercier, Sunnyvale, CA (US)

Correspondence Address: WORKMAN NYDEGGER;(F/K/A WORKMAN NYDEGGER & SEELEY), 60 EAST SOUTH TEMPLE, 1000 EAGLE GATE TOWER, SALT LAKE CITY, UT, 84111, US

(21) Appl. No.: 11/441,509

(22) Filed: May 24, 2006

Related U.S. Application Data
(60) Provisional application No. 60/683,956, filed on May 24, 2005.

(51) Int. Cl. G06F 15/173

(52) U.S. Cl. 709/224

(57) ABSTRACT

Characterizing a storage area network (SAN). Out-of-band information can be received from a SAN device. The information describes a SAN device type to which the SAN device belongs. Out-of-band information is received from the SAN device describing a performance characteristic of the SAN device. Relationships between the SAN device and other devices within the SAN are identified based on the out-of-band information received. The out-of-band information received is analyzed to identify a vulnerability in the SAN. In-band-data can also be received and analyzed to identify the vulnerability. The analysis can be conducted by a policy based data path analyzer device. Automated provisioning can be conducted based on the vulnerability identified.

### CROSS-REFERENCE TO RELATED APPLICATIONS

This application claims the benefit of U.S. Provisional Patent Application No. 60/683,956 filed May 24, 2005, the contents of which are hereby incorporated by reference herein.

### BACKGROUND

A Storage Area Network (SAN) is a switched network designed to attach computer storage devices, such as disk array controllers and tape libraries, to servers. Many different types of SAN protocols and infrastructures exist. For example, one common SAN technology is Fibre Channel networking with the small computer system interface (SCSI) command set. A typical Fibre Channel SAN is made up of a number of Fibre Channel switches which are connected together to form a fabric. A more recently employed SAN protocol is iSCSI which uses the same SCSI command set over TCP/IP (and, typically, Ethernet). In this case, the switches are Ethernet switches. Another protocol is FICON (Fiber Connectivity). FICON is an input and output protocol used in IBM mainframe computers and peripheral devices such as storage arrays and tape drives. It takes the ESCON channel protocol, and maps it onto a Fibre Channel transport.

Connected to the SAN are one or more servers (hosts) and one or more disk arrays, tape libraries, or other storage devices. In the case of a Fibre Channel SAN, for example, the servers use special Fibre Channel Host Bus Adapters (HBAs) and optical fiber. iSCSI SANs, on the other hand, normally use Ethernet network interface cards, and often specialized TCP/IP Offload Engine (TOE) cards.

Conventionally, however, there have been limitations on the ability to monitor and analyze the SAN devices in a SAN. Therefore, improvements that would be advantageous are improved SAN asset management, monitoring of SAN devices, and generation of alerts and other logs and outputs if SAN devices are down, connections are compromised, or performance issues are identified within SAN fabrics.

### BRIEF SUMMARY OF SEVERAL EXAMPLE EMBODIMENTS

A method for characterizing a SAN is disclosed. The method includes receiving out-of-band information from a SAN device in the SAN describing a SAN device type to which the SAN device belongs. The method further includes identifying relationships between the SAN device and other devices within the SAN based on the out-of-band information received. The method further includes analyzing the out-of-band information received to identify a vulnerability in the SAN. The method can further include collecting in-band network traffic analysis metrics and faults which can characterize network traffic performance and identify SCSI or protocol errors and faults.

A method of displaying a topology describing a SAN is disclosed. The method is practiced in a computer system having a graphical user interface including a display, a data processing device, and a user interface. The method includes discovering devices and data paths within the SAN. As used herein, the term “data path” refers to a connection from two devices in a network. For example a data path can refer to a connection from a single storage volume to a server, which can include multiple SCSI initiators, switch connections, and target/LUNs. The method includes displaying device icons and connection icons of the SAN in the topology. The method includes displaying the data paths within the SAN in the topology. The method can include displaying SAN performance data and faults on the topology and updating the information as it changes. The method includes identifying occurrence of a link, server, and/or switch event in the SAN. The method includes updating the topology when an event occurs. The method can further include correlating events, SAN performance, and faults with data paths and notifying users about the impact to the data path.

A policy based data path analyzer is disclosed. The policy based data path analyzer includes an out-of-band interface configured to receive out-of-band information from a SAN device in a network describing a device type to which the SAN device belongs and a performance characteristic of the SAN device. The policy based data path analyzer can further includes an out-of-band interface configured to receive in-band SAN traffic information which describes SAN link performance, SCSI performance and protocol faults. The policy based data path analyzer further includes a data processing device configured to execute instructions stored on a computer readable medium. The policy based data path analyzer further includes a computer readable medium comprising executable instructions that cause the data processing device to perform functions when executed. The computer executable instructions cause the data processing device to create a model of the network to identify relationships between devices within the network based on the out-of-band information received when executed. The computer executable instructions cause the data processing device to analyze the out-of-band information received to identify a vulnerability in the SAN.

These and other features of the present invention will become more fully apparent from the following description and appended claims, or may be learned by the practice of the invention as set forth hereinafter.

### BRIEF DESCRIPTION OF THE DRAWINGS

To further clarify the above and other features of the present invention, a more particular description of the invention will be rendered by reference to specific embodiments thereof which are illustrated in the appended drawings. It is appreciated that these drawings depict only typical embodiments of the invention and are therefore not to be considered limiting of its scope. The invention will be described and explained with additional specificity and detail through the use of the accompanying drawings in which:

FIG. 1 illustrates a policy based data path analyzer according to an example embodiment;

FIG. 2 is a block diagram illustrating various hardware and software modules of a policy-based data path management, asset management, and monitoring apparatus according to an example embodiment;

FIG. 3 illustrates an example of a main monitoring screen presentation according to an example embodiment of the present invention;

FIG. 4 illustrates different tree-view presentations corresponding to different filtered views along with various commands that can be associated with the different components and subcomponents;

FIG. 5 illustrates several commands that can be provided along with the graphical presentation of the system;

FIG. 6 illustrates various menus and toolbar options that can be presented to a user by the various pull-down menus and toolbar selections;

FIG. 7 illustrates how filters can include commands to open topology views in a new window of the screen presentation or in a new tab of the screen presentation;

FIG. 8 illustrates an example screen rollup according to an example embodiment of the present invention illustrating various status information that can be presented for each component;

FIG. 9 illustrates an example status roll up screen according to an example embodiment of the present invention including examples of various status information that can be presented for each component;

FIG. 10 illustrates a screen presentation that includes various graphical indications of the status and operating parameters of the different components of the SAN;

FIG. 11 illustrates a screen presentation for creating and editing containers;

FIG. 12 illustrates several dialog boxes in which a server creation wizard can set up a server; and

FIG. 13 illustrates a method for characterizing a SAN.

### DETAILED DESCRIPTION OF SEVERAL EMBODIMENTS

The principles of the embodiments described herein describe the structure and operation of several examples used to illustrate the present invention. It should be understood that the drawings are diagrammatic and schematic representations of such example embodiments and, accordingly, are not limiting of the scope of the present invention, nor are the drawings necessarily drawn to scale. Well-known devices and processes have been excluded so as not to obscure the discussion in details that would be known to one of ordinary skill in the art.

Also, it will be appreciated that while embodiments are described in relation to SANs, the teachings are not limited to such environments. For example, concepts set forth herein may have applications in other existing and/or future network environments and protocols.

Several embodiments disclosed herein relate to gathering information for policy-based data path management, monitoring of SAN devices, and monitoring performance within SAN fabrics. Several embodiments include SAN device discovery and monitoring (e.g., of storage, HBA, and switch SAN devices) and detailed discovery of SAN device properties and status including logical device properties (e.g., volume, logical unit number (LUN) map, zone, fabric, port, etc.). Several embodiments include data path discovery and monitoring and service level policies for managed data paths based on availability. Monitoring can be based on device alerts, where available, and polling when device alerts are not available.

In-band and/or out-of-band data can be analyzed to characterize a SAN. The out-of-band data can be received using a direct connection between a SAN device and the policy based data path analyzer charactering the SAN. The direct connection can be an Ethernet connection, for example, or any other communication cable or link whether electrical, optical, wireless, or otherwise enabled.

The in-band data can include network data transferred in a link of the SAN. The in-band data can be received from a storage network traffic metric source. An example implementation of a storage network traffic metric source is a storage network tap coupled with a probe that calculates traffic metrics and detect protocol errors. A storage network tap is placed in-line between two devices of a SAN that are in communication over the link to which the network tap is coupled. The network tap extracts (or copies) network data transferred through the link and forwards the network data to a probe that monitors and calculates metrics. This data is provided to the policy based data path analyzer for analysis and association with SAN devices and data paths. The network data can be used by the system to characterize the SAN. For example, the network data can be analyzed to determine the layout of the SAN, events, device performance, device error, protocol error, data transfer rates and volume, etc. If hardware cannot be inserted in the fabric, a software probe may provide an alternative approach that allows a subset of statistics to be gathered directly from Fibre Channel switches through SNMP, for example. Probes deliver accurate, real-time Fibre Channel and SCSI statistics to a portal or other data processing device.

Several embodiments discussed herein discover devices in a SAN and determine how the SAN devices are being used. This information can be used to charge owners for the resources that they are using, for example. Several embodiments determine which SAN resources are being used by particular servers, identify SAN resources that are not being used, identify resources not being efficiently used, identify data paths that exist between volumes and servers, identify and diagnose SAN alerts and failures, identify SAN resources that have errors or are unavailable, identify weakest links in a SAN, identify affected servers when a detrimental event occurs, and compare device performance to stored thresholds and templates to determine if the SAN devices are performing accordingly.

Policy-based data path management can include cross-vendor asset management and topology rendering for monitoring SAN devices along with alerts if devices are down or connections are compromised or performance impacted. Data paths can also be managed based on user-defined or manufacturer-defined policies. Monitoring aspects can include monitoring for performance and alerts within SAN fabrics.

Vulnerability audits of SAN configurations can also be provided. Examples of the types of vulnerabilities that the embodiments can identify include volumes mapped to unavailable servers, volumes without replicas, volumes without appropriate Redundant Array of Independent/Inexpensive Disks (RAID) protection, volumes with different LUN assignments through multiple controllers, volumes mapped to a single server connection, the number of volumes mapped to each storage port (storage port utilization), the number of volumes mapped to each HBA (HBA port utilization), detached connections, unavailable switches, the ratio of ISL connections to target (storage or HBA) connections on each switch, volumes mapped to an invalid HBA, volumes mapped to a controller port open to all servers, fabrics with no activated zones, zoned switch ports without a connected server, zones with an invalid server or storage subsystem, zones with potential impacts due to size or vendor conflict, recent failures and errors on switch ports, recent occurrences of loss of synchronization, recent occurrences of loss of signal, recent occurrences of link resets or failures, and/or recent occurrences of CRC errors.

1. Example Apparatuses

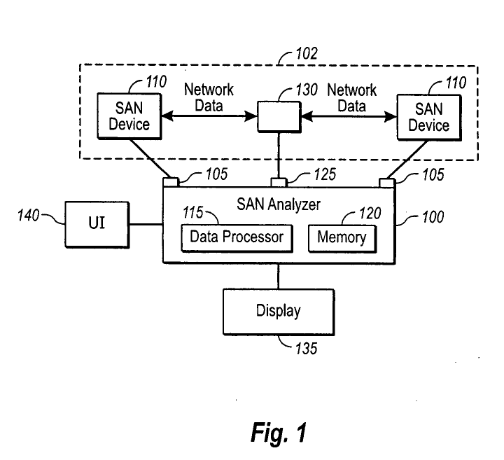

Referring to FIG. 1, a policy based data path analyzer 100 for analyzing a SAN 102 is illustrated according to an example embodiment. A policy based data path analyzer can comprise, or consist of, for example, a network tap, network probe, network portal, network analyzer, a in-band metrics source, a computer readable medium including computer executable instructions configured to cause a data processing device to perform any combination, permutation, or multiplicity of the acts and steps set forth herein.

The policy based data path analyzer 100 includes out-of-band interfaces 105 configured to receive out-of-band information directly from at least one SAN device 110. The information received from the SAN device 110 describes a SAN device type to which the SAN device 110 belongs. For example, the SAN device type may be a server, switch, storage device, port connection, fabric, or any other SAN device type within the SAN 102. The SAN device type can also include a description of a vendor or manufacturer of the SAN device 110, model number, intended operation performance characteristic, and other information characterizing the SAN device 110.

The out-of-band information received from the SAN device 110 can also include a performance characteristic of the SAN device 110. For example, the information received from the SAN device 110 can include information describing a data transfer rate by the SAN device 110, information describing an amount of data received by the SAN device 110 during a time frame, information describing errors, and information describing a loss of signal or loss of synchronization occurrence.

The policy based data path analyzer 100 further includes a data processing device 115, for executing computer executable instructions stored in a computer readable medium 120. The computer readable medium 120 includes executable instructions that cause the data processing device 100 to perform functions when the computer executable instructions are executed by the data processing device 100. For example, according to FIG. 1, the computer executed instructions stored in the computer readable medium 120 cause the data processing device 115 to create a model of the SAN 102 by identifying relationships between the SAN devices 110 based on the out-of band information received from the SAN devices 110. The computer executable instructions stored in the computer readable medium 120 cause the data processing device 115 to analyze the out-of-band information received to identify a vulnerability in the SAN 102.

The policy based data path analyzer 100 illustrated in FIG. 1 can further include an in-band interface 125 configured to receive in-band network data. The in-band network data include data transferred between two SAN devices 110 in the SAN 102. The network data can be received by a in-band metrics source 130 and transferred to the policy based data path analyzer 100 via the in-band interface 125. In-band metrics source 130 can include or consist of a network tap, network probe, and/or network portal for example. It should be appreciated that the in band metrics source 130 can be part of the policy based data path analyzer 100 and additional components can be included for receiving the in-band network data and out-of-band information. The computer readable medium 120 can further include executable instructions that cause the data processing device 115 to analyze the in-band network data to identify a vulnerability in the SAN 102. The vulnerability can be a performance or data error identified by the data processing device 115. For example, the vulnerability can be a performance error, protocol error, or data corruption.

The policy based data path analyzer 100 can include a display 135 and a user interface (UI) 140. The computer readable medium 120 can further include executable instructions that cause the data processing device 115 to generate a topology of the SAN 102 and display the topology of the SAN 102 on the display 135 along with an indication of a vulnerability identified from analysis of the out-of-band and/or in-band data. The embodiment illustrated in FIG. 1 may have many out-of-band interfaces 105 and/or in-band interfaces 125 coupling the policy based data path analyzer 100 to any number of SAN devices 110 and/or SAN links. Moreover, the policy based data path analyzer 100 can receive only out-of-band information or only in-band network data, and thus, the in-band interface 125 or the out-of-band interfaces 105 can be excluded. The computer readable medium 120 can further include executable instructions that cause the data processing device 115 to perform any of the acts and steps of the methods disclosed herein in any combination, permutation, and multiplicity. The policy based data path analyzer 100 may include a special purpose or general-purpose computer including various computer hardware or software modules.

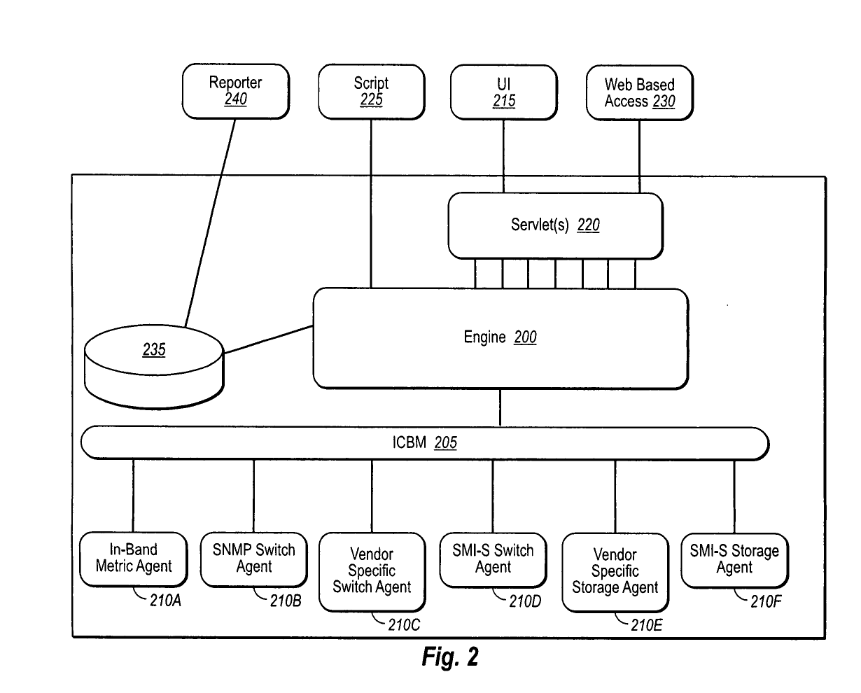

Referring to FIG. 2, a block diagram is shown illustrating various hardware and software modules of a policy-based data path management, asset management, and monitoring apparatus according to an example embodiment. The apparatus can include an engine 200 and a communication backend multiplexer (ICBM) 205 coupled to the engine 200. The ICBM 205 can be coupled to various agents 210A-F for receiving data from SAN devices and network data from a link of a SAN. As illustrated, the ICBN 205 can be coupled to a Simple Network Management Protocol (SNMP) switch agent 210B, a vendor specific switch agent 210C, a Storage Management Initiative-Specification (SMI-S) switch agent 210D, a vendor specific storage agent 210E, and a SMI-S Storage agent 210F for receiving out-of-band information from the respective SAN devices coupled to the agents. The various agents 210B-F discover SAN devices in the SAN and monitor performance and vulnerabilities.

The ICBM 205 is also coupled to an in-band metric agent 210A. The in-band metric agent 210A communicates with hardware tapped into a link of the SAN. For example, the in-band metric agent 210A can receive network data from a network tap. The network data represents data transmitted in a link of the SAN. The network data can include data received from several (or many) network taps extracting network data from respective links of the SAN.

The ICMB 205 is also coupled to the engine 200. The engine receives information from the agents 210 regarding the SAN devices and analyzes this information to detect vulnerabilities in the SAN. The engine 200 can also generate a topology of the SAN including errors, performance parameters, alerts, notifications, relationships between the SAN devices, and can display this topology on a monitoring user interface 215 via a servelet 220, such as Apache TomCat servelet container. The engine 200 also communicates with scripts 225 (e.g. via isexec) for collecting information and data. Web based access 230 to the engine 200 can also be provided via the servlet(s) 220.

The embodiment illustrated in FIG. 2 can also include a database management system 235, such as a SQL server, coupled to the engine 200. A reporter 240 can also be coupled to the data base management system 235 for populating and generating reports. The engine 200 can access and execute executable instructions for generating a notification, an alert, an event, a topology, or a report. The engine 200 can include or have access to executable instructions for discovery of SAN devices, their properties, relationships, and status; and monitoring of the SAN devices, data paths, fabric performance, reporting, infrastructure charging, and monitoring.

The system illustrated in FIG. 2 can further include computer executable instructions for performing at least one of the following: SAN device discovery and monitoring (storage, HBA, switch), discovery of SAN device properties and status, discovery of SAN logical device properties (Volume, LUNmap, Zone, Fabric, Port), data path discovery and monitoring, service level policies for managed data paths based on availability, SAN device topology viewing with automatic updates of connection and device availability, SAN switch link capacity and utilization displayed via topology with automated updates, SAN switch port alerts displayed via topology with automated updates, user defined and saved visual effects for viewing performance, alerts, and availability, filtered topology views that show data paths by owner with automatic updates, subscription-based alerts supporting device and logical alert types, multiple alert categories, filters based on severity, alert targets support including log, email, SNMP traps, or reporting. The engine 200 illustrated in FIG. 2 can access and execute computer executable instructions for performing any of the other steps and acts set forth herein.

The UI 215 can display topology views that include icons and characters representing SAN devices, connections, performance attributes, and errors. The topology view can be automatically updated with connection statuses and device statuses. SAN switch link capacity, utilization, and port alerts can also be displayed on the topology with automated updates. The user can define the visual effects for viewing fabric performance, alerts, and connection availability. Filtered topology views can allow users to reduce the SAN infrastructure shown in the topology. For example, views can be filtered by owner and location. Users can be able to assign devices to locations and discovered data paths to owners to enable filtered topology views based on these parameters. Events can also be filtered to show only events of a particular owner or location on a filtered view.

In one embodiment, the UI 215 can be a Java application and can communicate to the engine 200 via http, for example using Apache TomCat. The UI 215 can support secure http (https) communication between the UI 215 and Apache. Servlets 220 in Apache TomCat can communicate with the Engine 200 via isexec, for example. Apache TomCat can be local with the engine 200 and can use unique sessions for each user with rules for that particular user during the session. The UI 125 may be remote or local and can have many simultaneous instances. Users can select from a set of pre-defined visual effects for the topology views. Access to the engine 200 can be controlled, for example by logins which require user name and password.

Various out-of-band metrics can be received by the engine 200. For example, these metrics can be returned along with a switch port counter value, a switch port counter's prior value, and a timestamp of a poll which resulted in the switch port counter value. Examples of metrics include amount (e.g., bytes) of data transmitted or received by the SAN device during a time period, number of frames transmitted or received by the SAN device during a time period, cyclic redundancy check (CRC) errors, receive or transmit link resets, link failures, loss of signal and/or loss of synchronization occurrences and frames discarded by a SAN device.

Various statistics can be calculated by the engine 200 and returned with a calculated value, prior calculated value, and/or timestamp of the last poll for the metrics used to calculate the statistic. Examples of statistics include receive data rate, transmit data rate, receive capacity, transmit capacity, and port speed. Use of the value speed can be provided for calculating capacity. The user can also input a command to inquire as to the last time that a SAN device was polled.

Various in-band metrics can be received by the engine 200 from the in-band metric agent 210A. For example, there can be fibre channel link events, fibre channel link groups for a channel, SCSI link pending exchange metrics for a channel, end device conversation information for an initiator, target, LUN ITL, drive performance metrics for an ITL, exchange metrics for read, write, other for an ITL, and pending exchange metrics for an ITL. Essentially any metric characterizing a SAN by analyzing in-band network data an be received by the engine 200. Table 1, shown below illustrates examples of in-band metrics.

TABLE 1

| Example In-Band Metrics | Description |
|---|---|
| Fibre channel link events for a | # Loss of Sync |
| channel | # Loss of Signal |
| | # LIPs |
| | # NOS and OLS sequences |
| | # FC ELS Frames (PLOGI, etc.) |
| | # FC Service Frames |
| | # Fabric Frames (SOF(f) for E-port) |
| | # Basic Link Service Frames |
| | # Link Control Frames |
| | # Link ups (ret to idle after LOS, etc.) |
| | # SCSI Check condition status frames |
| | # SCSI Bad status Frames (queue full.) |
| | # SCSI Task Mgmt Frames |
| | # FC code violations |
| | # Frame errors |
| Fibre Channel Link Groups for | # Logins Frames (FLOGI, PLOGI, etc) |
| a channel | # Logouts (LOGO, PRLO, etc.) |
| | # Abort Seq Frames |
| | # Notification type frames (RSCN, etc.) |
| | # Reject type frames |
| | # Busy type frames (P_BSY, etc.) |
| | # Accept type frames |
| | # Loop Init Frames |
| SCSI Link Pending Exchange | # SCSI Exchanges opened |
| Metrics for a channel | Min # of SCSI Exchanges open at a time |
| | Max # of SCSI Exchanges open at a time |
| End Device Conversation | # Frames/sec used by SCSI exchanges |
| Information for an ITL | # MB of frame payload/sec between ITL |
| | # SCSI Task mgmt Frames |
| | # SCSI Bad status Frames |
| | # SCSI check condition status frames |
| | # SCSI exchanges aborted (ABTS) |
| Drive Performance Metrics for | Total elapsed time (ms) from SCSI Read to first data for |
| an ITL | all exchanges completed |
| | Maximum amount of time (ms) from SCSI Read to first |
| | data for all exchanges completed |
| | Minimum amount of time (ms) from SCSI read to first |
| | data for all exchanges completed |
| Exchange Metrics for Read, | # Frames/sec used by all R/W/O exchanges |
| Write, Other, for an ITL | # MB/sec used by all R/W/O exchanges |
| | # R/W/O commands issued |
| | # R/W/O commands completed |
| | Tot elapsed time (ms) for all SCSI R/W/O exchanges |
| | Min elapsed time (ms) per SCSI R/W/O exchanges |
| | Max elapsed time (ms) per SCSI R/W/O exchanges |
| | Min # data bytes for any SCSI R/W/O exchange |
| | Max # data bytes for any SCSI R/W/O exchange |
| Pending Exchange Metrics for | Pending Exchanges: The number of exchanges that have |
| an ITL | been open but not closed since both the probe and Portal |
| | have been monitoring a link. |
| | Minimum number of exchanges open at one time during |
| | an interval. |
| | Maximum number of exchanges open at one time |
| | during an interval |

2. Example GUI Presentations and Methods for Displaying Topologies

Several different embodiments of GUI interactive screen presentations can be generated by the engine and each presentation can include various means for gathering information and instructions from a user. The information and instruction gathering means can include menus, data entry fields, selection menus for navigation through various graphical presentations, and selection menus for modifying performance parameters of the corresponding software modules. A user can in turn input information and instructions into the information and instruction gathering means which are communicated to the engine.

The GUI can interact with the software modules discussed herein to receive an instruction from a user to query SAN devices, to monitor different SAN devices of a SAN, monitor different aspects of performance of a monitored system, to trouble shoot a particular system with identified errors, and/or for any other purpose identified herein. The GUI can further receive an indication from the user for a desired format to display such information to the user. Different formats for displaying presentations to a user are illustrated below and described in further detail.

Several different presentations can be presented to a user simultaneously and in different configurations. Thus, the following GUI screen presentations are for purposes of providing an example of a GUI environment that can be implemented in various architectures to provide interaction with a user according to example embodiments of the present invention.

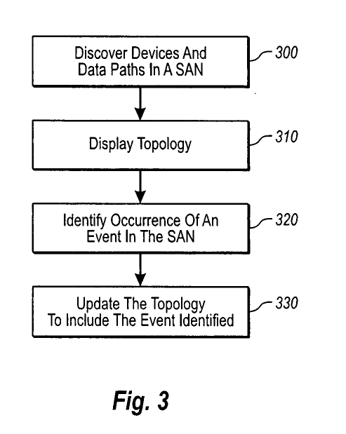

The GUI presentations discussed herein that include SAN topologies can be generated by various methods including any combination, permutation and/or multiplicity of steps and acts. For example, referring to FIG. 3, a method for displaying a topology describing a SAN is illustrated. The method includes discovering devices and data paths within the SAN (300). The SAN devices and data paths can be discovered by analyzing out-of-band and/or in-band data. The various relationships between the SAN devices and data paths can also be identified by analyzing the in-band and out-of-band data.

Topology is generated by determining the relationships between the SAN devices and constructing a relationship matrix. Device icons and connection icons of the SAN are displayed in a visual topology (310). data paths within the SAN are also displayed in the topology. Menu selections can be collapsed based on logical groups and settings, and device icons can displayed in logical groups represented by a single icon. The device and connection icons of the SAN can be displayed along with color indicating attributes of the particular device or connection, such as whether each device or connection is online or offline. Different colors or lack of color can be used to indicate whether each device is online or offline based on user defined thresholds to define online and offline.

The method further includes identifying an occurrence of an event in the SAN (320). The event can be any event discussed herein including out-of-band configuration and relationship and errors detected and in-band traffic protocol faults and performance changes. The method further includes associating in-band and out-of-band information with the topology and data paths and updating the topology when with an indication of the event the event occurs in the SAN (330). A history of connection alerts can also be displayed along with the topology. A user can also be queried using means for receiving information and instructions using a UI displaying the topology.

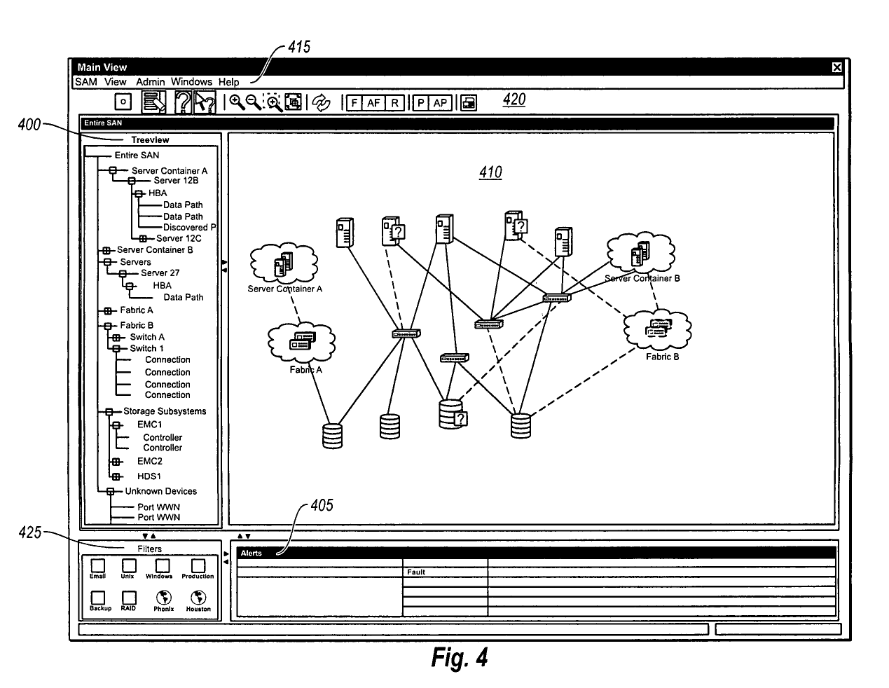

FIG. 4 illustrates an example of a main monitoring screen presentation according to an example embodiment of the present invention. The main monitoring screen can include several windows for displaying SAN information and control information to a user. The screen can include a treeview 400 that is a tree diagram illustration of the various components of the SAN. The treeview 400 can be automatically updated depending on the status of the components and subcomponents of the SAN and how these components and subcomponents interact. For example, the SAN illustrated in the treeview 400 can include several server containers, servers, fabrics, and storage subsystems. The different branches of the treeview 400 can be expanded and collapsed to provide information about the SAN in a user customizable manner. The treeview 400 can change in different screen presentations depending on different filters. The treeview 400 can also include different commands associated with the different components and subcomponents of the treeview 400.

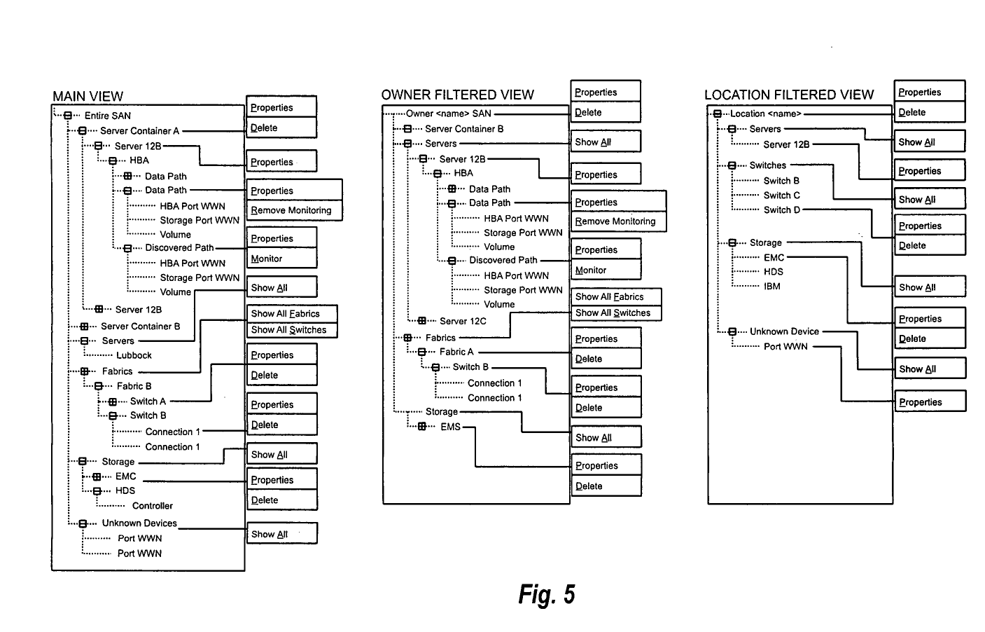

For example, FIG. 5 illustrates different tree-view presentations corresponding to different filtered views along with various commands that can be associated with the different components and subcomponents.

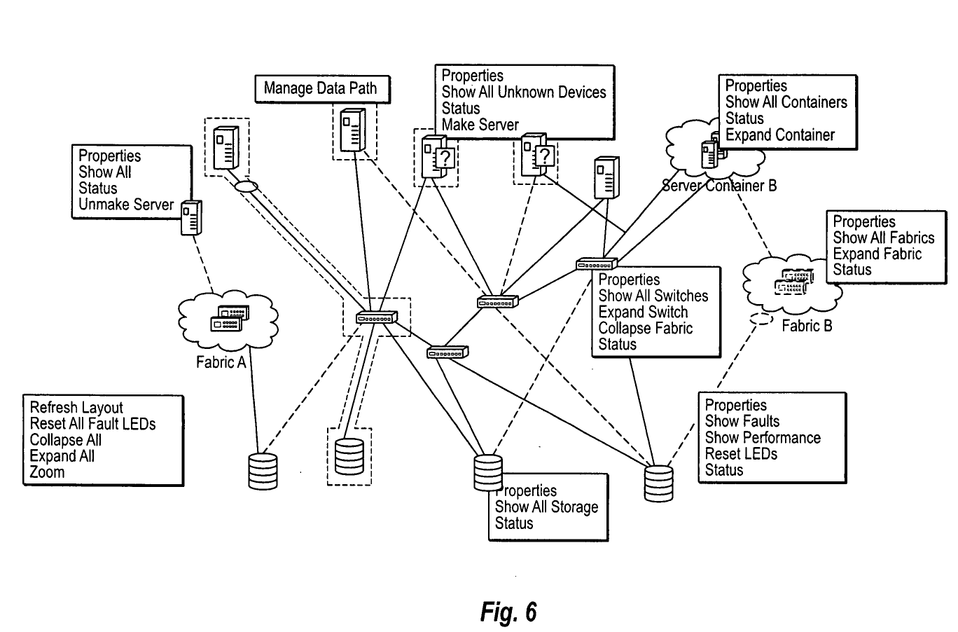

The main monitoring screen illustrated in FIG. 4 can further include an alerts window 405 for alerting a user to any errors identified in the SAN. The main monitoring screen can include a graphical SAN presentation window 410 for providing a viewer with a graphical indication of the various components of the SAN and the various interconnections between the components and subcomponents of the SAN. There can be topology commands associated with the different components displayed on the graphical SAN presentation. For example, FIG. 6 illustrates several commands that can be provided along with the graphical presentation of the system.

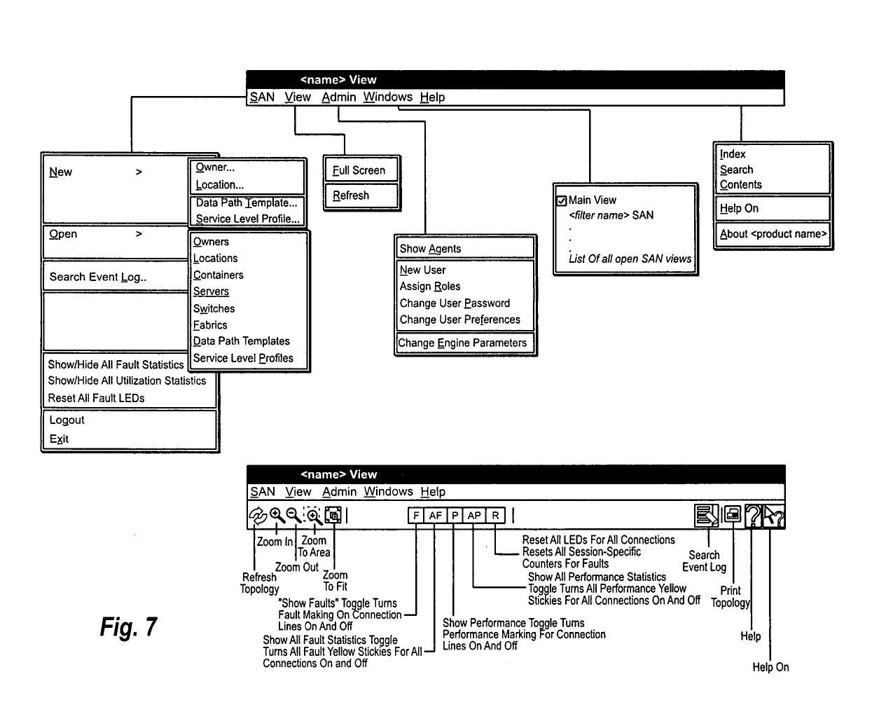

The Main view illustrated in FIG. 4 can further include various pull-down menus 415 and a toolbar 420 for navigation, manipulation and user input. For example, FIG. 7 illustrates various menus and toolbar options that can be presented to a user by the various pull-down menus and toolbar selections.

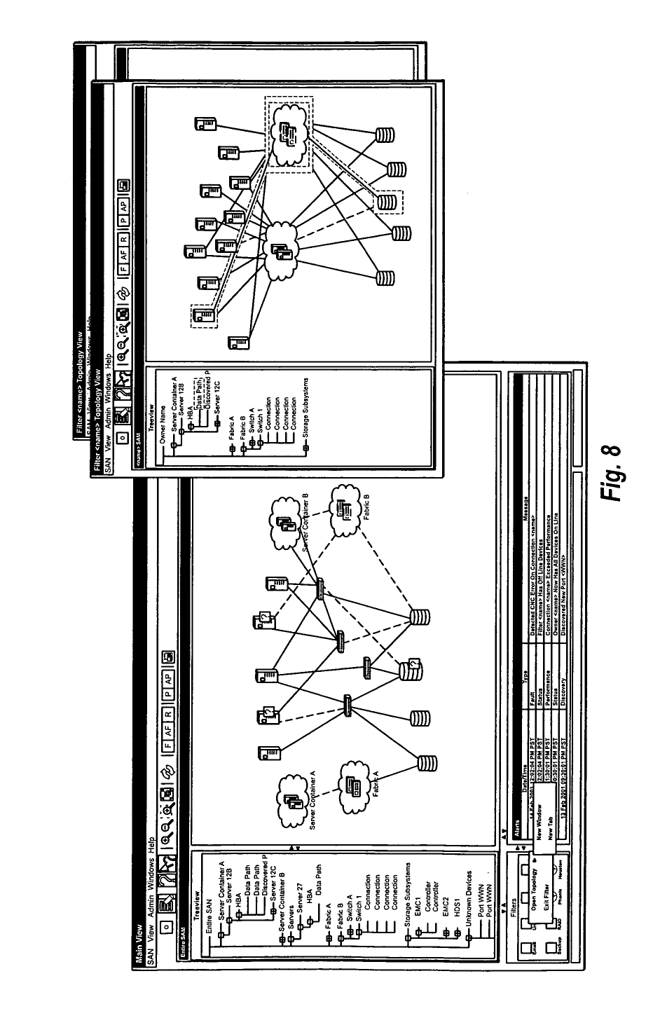

The main monitoring screen illustrated in FIG. 4 can further include various filters that are graphically presented in a filters window 425. When a user changes tabs in the filters window 425, the topology 410 and tree-view 400 can both be repopulated. When a user quits a session and restarts, filters 425 can be docked the same way that they were left. A filter 425 can be either an owner or a location, for example. Devices may belong to both an owner and a location. For locations, any device can be assigned to a location, even if it is a member of a container. The filters 425 can include commands to open topology views in a new window of the screen presentation or in a new tab of the screen presentation as illustrated in FIG. 8.

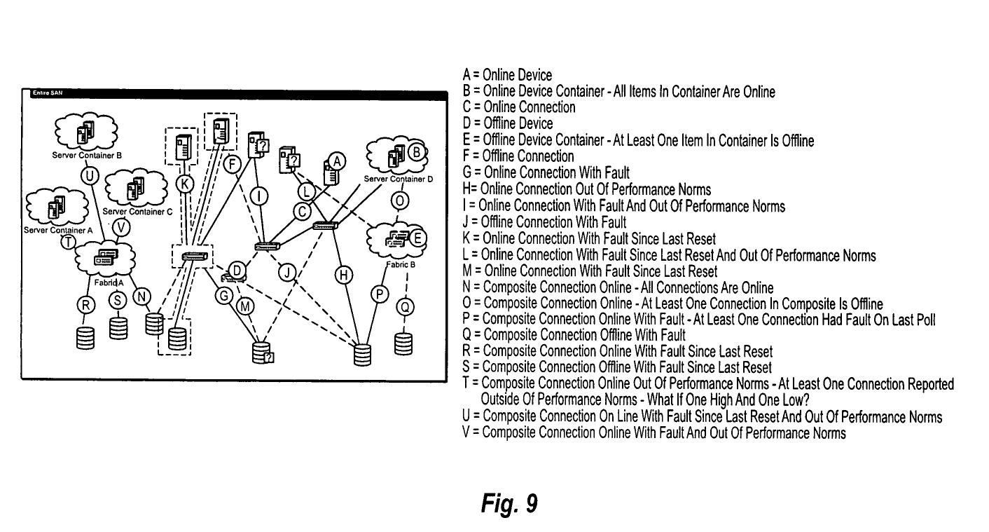

A status rollup screen can be presented to a user describing statuses of the different components of the system. For example, FIG. 9 illustrates an example status roll up screen according to an example embodiment of the present invention including examples of various status information that can be presented for each component.

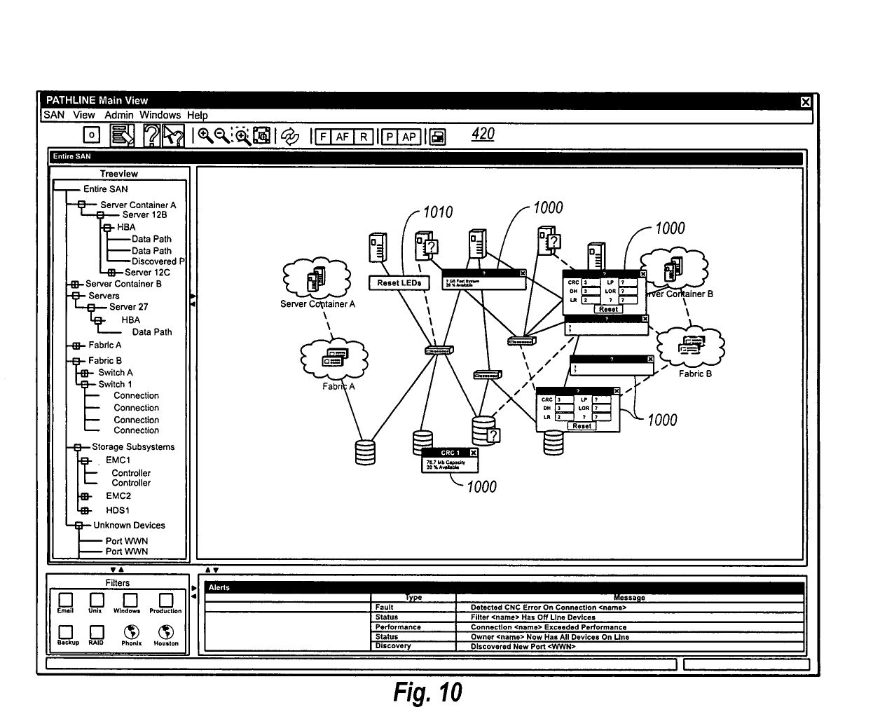

The main screen illustrated in FIG. 4 can also show online/offline status and fault status of the different components graphically. For example, FIG. 10 illustrates a screen presentation that includes various graphical indications 1000 of the status and operating parameters of the different components of the SAN system where a “show alerts” option is selected. An indicator 1010 can show up on a connection when a fault is detected. The indicator 1010 can change to a different color when the fault is not detected on the next poll. Indicators 1010 can disappear, for example, when the user wishes to reset. Aggregate connections can show a roll-up of fault detection using an algorithm. Mouse-over can bring up fault statistics on a link or a user can choose to permanently display performance and fault statistics

A “Show Fault” toggle and a “Show Performance” toggle are “on” in FIG. 10 resulting in a main view presentation. Graphical neumonics can be used to quickly describe SAN link and data path performance and faults. Examples are: Lines can be dashed when performance or utilization falls below user-defined norms; Lines can be solid when performance and/or utilization are at user-defined norms; Lines can be dash-dot when above norms. Link statistics can list connection capacity and % utilization and be refreshed continuously.

Users can determine their preferences for specifying thresholds for low and high performance, and for specifying a password or logon preferences.

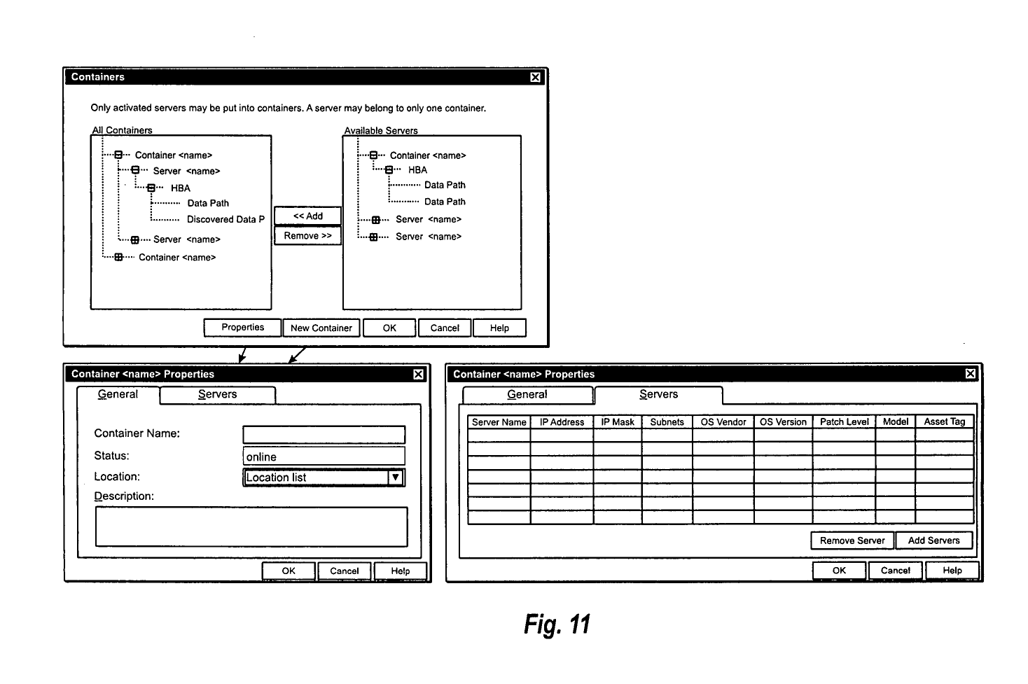

The servers can be organized into containers and this organization can be graphically displayed and graphically edited by a user to generate topology of interest to the user. Referring to FIG. 11 a screen presentation for creating and editing containers is shown according to an example embodiment of the present invention. The containers can be displayed in a tree format and servers can be added and removed from containers using a selection of add and remove buttons of the graphical display, for example. The properties of the containers and servers can also be edited using dialog boxes.

Dialog boxes and other windows can be presented for displaying statistics and allowing for control of the display related to switches and fabrics. Additional descriptions of the switches and fabrics can be added to the dialog boxes and additional tabs for viewing and defining different attributes, such as port and active fabric switch zones, zone sets and virtual SAN settings, can be displayed.

A dialog box describing a port connection and its properties can be displayed. The port connection dialog box can provide a port connection identification, a status of the port, a switch port along with properties of the switch port and an attached port along with properties of the attached port. A window can be displayed along with a historical view of alerts and/or current alerts detected for the port.

Additional windows and dialog boxes can be provided describing the various servers, data paths, and storage subsystems and properties of the SAN. Storage system dialog boxes can describe the components of the SAN such as volumes, controllers, controller ports, drives, and LUN Maps. There can be additional windows and dialog boxes that describe properties of the volumes, controllers, controller ports, drivers, and LUN Maps.

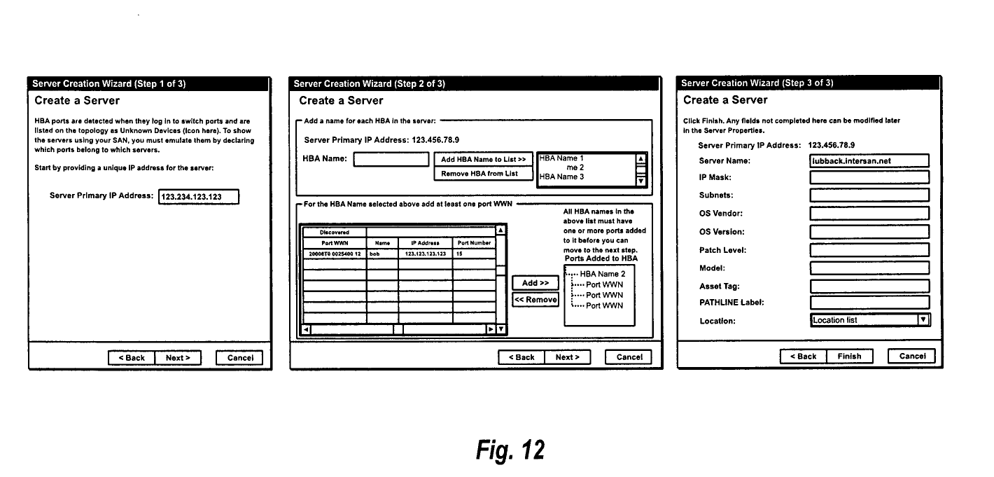

Wizards can be provided for designing, customizing and setting up policies desired for data path management, asset management, and monitoring device. For example, referring to FIG. 12, several dialog boxes are shown illustrating a method in which a server user may specify the HBAs within a SAN attached server and describe any attributes about the server. This information is used to analyze Data Paths and verify their configuration and detect vulnerabilities. This example uses three dialog boxes in succession to illustrate an example of the types of information and options that can be displayed and received by such a wizard.

3. Examples of SAN Events, Vulnerabilities, and Alerts

An alert is the engine's interpretation of an event or group of events that occurred in the SAN. In response to events, the engine can generate alerts. Alerts can be divided into alert types, which can include device alerts and logical alerts. Device alerts can be created for events that affect SAN devices, such as servers, switches, storage, port connections, fabrics, zones, zonesets, etc. Logical alerts can be created for logical abstractions like owners, applications, data paths, storage domains, locations, etc.

Alerts can also be categorized. Categories of alerts include discovery alerts and status change alerts. Discovery alert categories can be created for discovery of previously unknown device or logical objects. Status change alert categories can be created when devices or logical objects change status.

Alerts can be associated with SAN traffic or resources such as utilization, bandwidth, SCSI checks, aborts, etc. Alarms and reports can also be generated for other metrics as well. For example, delays within a fabric or WAN (between multiple fabrics) may impact the operation of the entire SAN thereby generating alarms and reports.

An engine (for example see FIG. 2) can generate events when an agent notifies the engine that a SAN device being monitored has changed. Change can include the discovery of new SAN devices or logical devices, the removal of SAN devices or logical devices, or changes to devices or their status. data path events can also be created by the engine when a data path is impacted or goes offline due to device failures reported by the agents. Events can be generated by the engine when a policy (e.g., a performance threshold or best practices template) is out of compliance with the (SAN. Downtime can be used in calculating compliance and downtime can be accrued. Agents can send events when devices are not reachable (e.g., the connection is lost). These events can be logged and displayed. Events can be stored in a database in any manner, such as written to an .xml file.

Alert subscription policies can be defined in the engine. The user can subscribe to the policies through the engine command line interface, for example, specifying type and category, as well as severity and class ID.

Alert targets (where alerts are sent) can be defined in an alert notification policy. Examples of alert targets include a log file, a script, Simple Network Management Protocol (SNMP) trap, or email.

Any event that causes a change to an attribute in a discovered SAN device, including SLP compliance changes, can result in a notification. The engine can also send notifications for fabric port alerts.

Various reports can be generated. The reports can show devices, status, events, errors, etc. A reporter module can use Structured Query Language (SQL) commands to directly access the SQL Server database. Table 2, shown below, illustrates examples of information that can be gathered and reports that can be generated.

TABLE 2

| Report Name | Column contents |
|---|---|
| Managed data path Storage | Owner, Application, data path name, data path state, |
| Report | volume, RAID level, Presented Capacity (GB), Raw |
| | Capacity (GB) |
| Volume Allocation Report | Storage subsystem, volume, volume type, RAID level, |
| | is replica volume?, Presented Capacity (GB), Raw |
| | Capacity (GB), data path state, Application, Owner |
| HBA Inventory Report | Server Name, Location, OS Vendor, OS Version, HBA |
| | Vendor, HBA Model, HBA Serial Number, HBA BIOS |
| | version, HBA Firmware Version, HBA port WWN, |
| | HBA ports, IP Address, Total Volumes Allocated, |
| | Presented Storage Allocated (GB), Total Raw Storage |
| | Allocated (GB), Total Events on this HBA (e.g., over |
| | the last 30 days) |
| Owner Chargeback Report | Owner, Service Level Profile, Applications, Servers, |
| | HBA Ports Used, Total Volumes Allocated, Total |
| | Presented Storage Allocated (GB), Total Raw Storage |
| | Allocated (GB) |
| Weakest Links Report | Total Events on the link (e.g., over last 30 days), |
| | Device A Name, Device A IP Address, Device A Type |
| | (i.e., “HBA”, “Switch/Director” or “Storage” |
| | depending on the type of device), Device A Vendor, |
| | Device A Model, Device A Port Number, Device A |
| | Port WWN |
| | Device B Name, Device B IP Address, Device B Type |
| | (i.e., “HBA”, “Switch/Director” or “Storage” |
| | depending on the type of device), Device B Vendor, |
| | Device B Model, Device B Port Number, Device B |
| | Port WWN |
| Storage Subsystem Inventory | Storage Subsystem Name, Location, Vendor, Model, |
| Report | Serial Number, Controllers, Ports, Disks, Volumes, |
| | Presented Allocated Capacity (GB), Presented Free |
| | Capacity (GB), Presented % Allocated Presented |
| | Capacity, Total Presented Capacity (GB), Raw |
| | Allocated Capacity (GB), Raw Free Capacity (GB), |
| | Raw % Allocated Capacity, Total Raw Capacity (GB), |
| | Total Events on this system (e.g., over last 30 days) |
| Switch/Director Inventory | Switch/Director Name, Location, Vendor, Model, |
| Report | Firmware, Switch WWN, Fabric WWN, IP Address, |
| | Ports in Use, % Ports in Use, Total Ports, Active |
| | Zones?, Total Events on this switch/director (e.g., over |
| | last 30 days) |
| Enterprise-Wide Storage | Location, Applications, Servers, HBAs, HBA ports, |
| Summary Report | Switches, Switch Ports, Storage Subsystems, Storage |
| | Controllers, Storage Controller ports, Total Presented |
| | Allocated Storage (GB), Total % Presented Allocated |
| | Storage (GB), Total Presented Free Storage (GB), Total |
| | Presented Storage (GB) |
| | Total Raw Allocated Storage (GB), Total % Raw |
| | Allocated Storage (GB), Total Raw Free Storage (GB), |
| | Total Raw Storage (GB) |

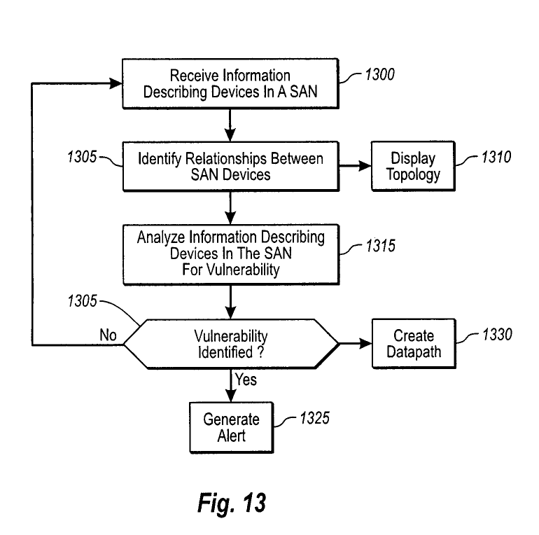

Referring to FIG. 13, a method for characterizing a SAN is illustrated. Information is received describing devices in the SAN 1300. The information can be include in-band network data and/or out of band information. The information can be out-of-band data received from at least one device in the SAN. The information can be in-band information received from a link of the SAN including network data transferred between two devices of the SAN. The in-band network data can be received from a network tap coupled to a SAN link between two SAN devices.

The information can describe a SAN device type and a performance characteristic of the SAN device. Out-of-band information can include a description of the vendor and/or manufacturer of the SAN device, information describing the type of device from which the information is received, information describing data transfer rate by the SAN device from which the information is received, information describing an amount of data received or transmitted by the SAN device during a time frame, information describing errors identified by the SAN device from which the information is received, and/or information describing a loss of signal or loss of synchronization occurrence.

Relationships between the SAN devices within the SAN are identified (1305) based on the information received. The relationships can be used to generate a topology (1310). The topology can be displayed along with visual representations (such as ICON's etc.) of the SAN devices, links, etc. of the SAN. The topology can also include indication of alerts, events, performance or any other indicia describing the SAN devices and performance parameters.

The information received is analyzed to identify a vulnerability (1315). The out-of-band information and the in-band network data received can both be analyzed to identify a vulnerability in the SAN. The in-band network data can be analyzed for protocol errors and/or data corruption. The in-band network data can also be analyzed to determine data transfer rates, volume of data transfer, and capacities of any of the SAN devices or links. The in-band network data and the out-of-band information can be analyzed simultaneously, in-turn, comparatively, heuristically, or in any other manner.

The analysis can include identifying and/or analyzing any event, including a device status, logical discover, and/or status event. The vulnerability can include any vulnerability discussed herein. For example, the vulnerability can include volumes mapped to unavailable servers, volumes without replicas, volumes without appropriate RAID protection, volumes with different LUN assignments through multiple controllers, volumes mapped to a single server connection, the number of volumes mapped to each storage port (storage port utilization), the number of volumes mapped to each HBA (HBA port utilization), detached connections, unavailable switches, the ratio of ISL connections to target (storage or HBA) connections on each switch, volumes mapped to an invalid HBA, volumes mapped to a controller port open to all servers, fabrics with no activated zones, zoned switch ports without a connected server, zones with an invalid server or storage subsystem, zones with potential impacts due to size or vendor conflict, recent failures and errors on switch ports, recent occurrences of loss of synchronization, recent occurrences of loss of signal, recent occurrences of link resets or failures, and/or recent occurrences of CRC errors.

The act of analyzing the information (1315) can include comparing the information to historical data stored in a computer readable medium. The historical data can include previously received information describing the SAN devices or network data transferred between SAN devices. The historical data can include a baseline. The baseline can define a range of values defined by historical values collected. For example, a received value can be compared to a range of values received in the past defining the baseline. If the received value is higher or lower than the baseline values an alert can be generated. The act of analyzing the information can also include comparing the information to a SAN device template. The SAN device template can include threshold performance parameters for the SAN device.

The act of analyzing the information (1315) can include determining an operation parameter of a SAN device in the SAN: For example, the rate of data transfer by the SAN device, the number of volumes in the SAN, the number of ports used by a switch, and/or a volume of storage used in a volume of the SAN can be determined from the analysis.

The act of analyzing the information (1315) can also include comparing the out-of-band data to a threshold and generating an alert when the information violates the threshold. The SAN device template includes threshold performance parameters that are specified by a manufacturer or vender of the SAN device. The SAN device template can also include threshold performance parameters that are created by user or any other entity for internal data center best practices.

If a vulnerability is identified (1320), an alert is generated (1325). The alert can be a machine identification of a vulnerability by analyzing events. The alert can be transmitted to a target. The alert can also be indicated on a topology and automatically updated.

The alert can identify volumes mapped to unavailable servers, volumes without replicas, volumes without appropriate RAID protection, volumes with different LUN assignments through multiple controllers, volumes mapped to a single server connection, inefficient storage port utilization, inefficient HBA port utilization, detached connections, unavailable switches, volumes mapped to an invalid HBA, volumes mapped to a controller port open to all servers, fabrics with no activated zones, zoned switch ports without a connected server, zones with an invalid server or storage subsystem, zones with potential impacts due to size or vendor conflict, recent failures and errors on switch ports, occurrences of loss of synchronization, occurrences of loss of signal, occurrences of link resets or failures, occurrences of CRC, discovery of a storage device, HBA, or switch in a SAN, identification of a property and/or status in the SAN, and/or detection of data paths that do not meet a template of properties for server connections, switch connections, fabric zoning storage subsystem connections, volume size, SAN device performance attributes, and/or volume type.

Where a vulnerability is not detected (1320), additional information can be received (1300). The additional information can include current status, performance, and other properties of the SAN devices along with any changes to the information since the previous information was received. The method of FIG. 13 can be repeatedly performed to automatically update topologies, reports, and alerts.

4. Provisioning a SAN Based on SAN Characteristics and Vulnerabilities

Methods for provisioning a SAN are set forth in U.S. patent application Ser. No. 10/896,408, the contents of which are incorporated herein by reference. After a SAN is characterized using the methods discussed above, a data path can be created for a process executing on a server coupled to the SAN. For example, referring again to FIG. 13, if a vulnerability is identified (1320), a data path can be created (1320). The data path can be created (1320) based on a set of attributes for a desired data path between the process and the storage device of the SAN. These attributes can be defined by a template, for example. The data path can be created (1320) that provides the set of attributes, or the best set of attributes according to the template.

An operator, rather than a highly trained storage and switching expert, is able to perform automated provisioning which results in the creation of a data path (1320) between a server and data. Details of the SAN architecture, including, for example, server configurations, processes executable on specific servers and association of the processes with the server, other SAN devices and configurations of the switching network, and SAN devices and configurations of the storage architecture are discovered as discussed above.

Not only is static information determined, but dynamic information and state information as well. A data path Engine can execute computer executable instructions that cause the data path Engine to initiate, control and monitor the discovering, saving, using, configuring, recommending, and reporting acts discussed above. The data path Engine calculates the optimal data path based upon the rules or policies and information learned about the SAN, including policies and rules defined in the preconfigured or generated templates for interaction with the data path Engine. As used herein, the term template is defined to include, for example, a list of defined rules and policies which define the storage characteristics and data path characteristics that can be used by the data path Engine for selection of a data path. The template can be created in advance by an administrator using a graphical wizard, for example. The template can also include information and rules generated by a manufacturer of the SAN devices.

A method of creating a data path for a process executing on a server coupled to SAN includes parameterizing a set of attributes for a desired data path between the process and a device of the SAN and constructing the data path that provides the set of attributes. For purposes of this application, the term attributes includes details about data volumes, security settings, performance settings, and other device and policy settings, and parameterizing is defined to include defaults selected by the system to help the administrator make better choices when creating a template which reflects data path policy and rules; with parameterizing attributes referring to an abstraction of the configuration, implementation and creation steps to identify the desired end product without necessarily specifying implementation details.

The data path may contain multiple channels or threads. A thread is a logical relationship representing a physical path between the server on which the application is resident and all of the devices, connections, ports and security settings in between. Further, for purposes of this application, threads are defined to include one or more of, depending upon the needs of the embodiment, application id, server id, HBA port id, HBA id, HBA security settings, switch port ids, switch security settings, storage subsystem port id, data volume id, data volume security settings, SAN appliance port id, SAN appliance settings. These relationships include, but are not limited to, the data volume; the storage subsystem the volume resides on; all ports and connections; switches; and SAN appliances and other hardware in the data path; the server with the HBA where the application resides; and all applicable device settings. The data path selection is based upon policies such as, number of threads, number of separate storage switch fabrics that the threads must go through, level of security desired and actions to take based upon security problems detected, performance characteristics and cost characteristics desired. data paths are created 1330 from SAN devices automatically discovered by the data path Engine (Applications, Servers, HBAs, Switches, Fabrics, Storage Subsystems, Routers, Data Volumes, Tape drives, Connections, Data Volume Security, etc.). The data path can have multiple threads to the same data volume and span physical locations and multiple switched fabrics.

An apparatus for selection and creation of the optimal data path among the candidate data paths can include a data path Engine that discovers information about the SAN as discussed above. The data path Engine automatically configures SAN devices for data path creation across multiple devices, networks and locations. Implementations of automated storage provisioning include but are not limited to, creation of data paths for an application, discovery of pre-existing data paths, reconfiguration of data paths, movement of data paths between asynchronous replications, and tuning of data paths based upon data collected about the SAN's performance and uptime. Pathing methodologies calculate the best data paths rather than relying on experts or operator memory to select the optimal path during setup. Complex storage networking hardware and services can be added to storage networks and quickly incorporated into new or existing data paths.

The data path Engine can store the templates in the specification of existing data paths (including policies/templates/rules) used in guiding the generation of each existing data path. Periodically (automatically or operator initiated), the data path Engine reruns the pathing methodologies based upon the stored parameters in the templates to determine whether a new optimal data path exists. Depending upon specific embodiments, the data path may be changed automatically or the user may be requested to authorize the use of the new data path.

As used herein, the term automatic means that all the underlying SAN infrastructure and settings are configured by the data path Engine without administrator intervention based solely on a request specifying an application, data volume size and template. The above description refers to the construction of a data path.

The embodiments described herein may include the use of a special purpose or general-purpose computer including various computer hardware or software modules, as discussed in greater detail below.

Although more specific reference to advantageous features are described in greater detail above with regards to the Figures, embodiments within the scope of the present invention also include computer-readable media for carrying or having computer-executable instructions or data structures stored thereon. Such computer-readable media can be any available media that can be accessed by a general purpose or special purpose computer. By way of example, and not limitation, such computer-readable media can comprise RAM, ROM, EEPROM, CD-ROM or other optical disk storage, magnetic disk storage or other magnetic storage devices, or any other medium which can be used to carry or store desired program code means in the form of computer-executable instructions or data structures and which can be accessed by a general purpose or special purpose computer. When information is transferred or provided over a network or another communications connection (either hardwired, optical, wireless, or a combination thereof) to a computer, the computer properly views the connection as a computer-readable medium. Thus, any such connection is properly termed a computer-readable medium. Combinations of the above should also be included within the scope of computer-readable media.

Computer-executable instructions comprise, for example, instructions and data which cause a general purpose computer, special purpose computer, or special purpose processing device to perform a certain function or group of functions. Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

As used herein, the term “module” or “component” can refer to software objects or routines that execute on the computing system. The different components, modules, engines, and services described herein may be implemented as objects or processes that execute on the computing system (e.g., as separate threads). While the system and methods described herein are preferably implemented in software, implementations in hardware or a combination of software and hardware are also possible and contemplated. In this description, a “computing entity” may be any computing system as previously defined herein, or any module or combination of modulates running on a computing system.

The embodiments described herein may also be described in terms of methods comprising functional steps and/or non-functional acts. Some of the previous sections provide descriptions of steps and/or acts that may be performed in practicing the present invention. Usually, functional steps describe the invention in terms of results that are accomplished, whereas non-functional acts describe more specific actions for achieving a particular result. Although the functional steps and/or non-functional acts may be described or claimed in a particular order, the present invention is not necessarily limited to any particular ordering or combination of steps and/or acts. Further, the use of steps and/or acts in the recitation of the claims—and in the following description of the flow diagrams—is used to indicate the desired specific use of such terms.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

We claim:

1. A method for characterizing a storage area network (SAN) comprising the following acts:
receiving out-of-band information from a SAN device in the SAN describing a device type to which the SAN device belongs;
identifying relationships between the SAN device and other SAN devices within the SAN based on the out-of-band information received; and
analyzing the out-of-band information received to identify a vulnerability in the SAN.

2. A method according to claim 1, further comprising generating an alert based on the vulnerability identified.

3. A method according to claim 2, wherein the alert includes a device type alert, a logical type alert, a discovery alert or a status change alert.

4. A method according to claim 1, wherein the act of analyzing the out-of-band information includes comparing the out-of-band information to historical data stored in a computer readable medium, the historical data including previously received information describing the SAN device.

5. A method according to claim 4, wherein the historical data includes a baseline, the baseline defining a range of values defined by a range of historical values received.

6. A method according to claim 1, wherein the act of analyzing the out-of-band information includes comparing the out-of-band information to a SAN device template, the SAN device template including a threshold for the SAN device.

7. A method according to claim 6, wherein the SAN device template includes threshold parameters that are created by a manufacturer or vender of the SAN device.

8. A method according to claim 6, wherein the threshold includes performance, configuration, and/or reliability parameters.

9. A method according to claim 6, wherein the SAN device template includes a user defined threshold parameter.

10. A method according to claim 9, wherein the user defined threshold parameter includes a best practice parameter that is created by a user input to a means for gathering information and instructions from the user.

11. A method according to claim 1, wherein the out-of-band information includes at least one of or any combination of a description of the vendor or manufacturer of the SAN device, information describing the device type, information describing data transfer rate by the SAN device, information describing an amount of data received or transmitted by the SAN device during a time frame, information describing errors identified by the SAN device, information describing a loss of signal occurrence, or information describing a loss of synchronization occurrence.

12. A method according to claim 1, further comprising:
receiving an in-band metric, the in-band metric being derived from in-band network data transferred in a link of the SAN between two SAN devices; and
analyzing both the in-band metric and analyzing the out-of-band information to identify a vulnerability in the SAN.

13. A method according to claim 12, wherein the in-band metric is received from an in-band metric source, the in-band metric source including a network tap coupled to the link and configured to extract and summarize network data transferred in the SAN across the link.

14. A method according to claim 12, wherein the network data is analyzed for protocol errors and/or performance slowdowns

15. A method according to claim 14, wherein the protocol errors include extended SCSI exchange completion times and long latencies.

16. A method according to claim 12, wherein the in-band metric and out-of-band information are analyzed simultaneously to identify the vulnerability.

17. A method according to claim 1, further comprising generating a topology of the SAN based on the modeling of the SAN.

18. A method according to claim 17, further comprising displaying the topology on an illuminated display or on a tangible medium.

19. A method according to claim 17, wherein the topology includes indicia indicating the vulnerabilities identified.

20. A method according to claim 1, wherein the SAN device type includes a manufacturer and/or model of the SAN device.

21. A method according to claim 1, further comprising detecting an existing data path.

22. A method according to claim 21, further comprising detecting an existing data path that does not meet a template.

23. A method according to claim 22, wherein the template is a predefined template that includes expected performance characteristics, best practices, and/or vendor requirements in configuration, or vulnerabilities.

24. A method according to claim 22, further comprising receiving an in-band metric and wherein the existing data path that does not meet the template is detected by analyzing both the in-band metric and out-of-band data.

25. A method according to claim 1, further comprising at least one of or any combination and multiplicity of the following acts:
detecting volumes mapped to unavailable servers;
detecting volumes without replicas;
detecting volumes without appropriate RAID protection;
detecting volumes with different LUN assignments through multiple controllers;
detecting volumes mapped to a single Server connection;
detecting the number of volumes mapped to each storage port (storage port utilization);
detecting the number of volumes mapped to each HBA (HBA port utilization);
detecting detached connections;
detecting unavailable switches;
detecting the ratio of ISL connections to target (storage or HBA) connections on each switch;
detecting volumes mapped to an invalid HBA;
detecting volumes mapped to a controller port open to all servers;
detecting fabrics with no activated zones;
detecting zoned switch ports without a connected server;
detecting zones with an invalid server or storage subsystem;
detecting zones with potential impacts due to size or vendor conflict;
detecting recent failures and errors on switch ports;
detecting occurrences of loss of synchronization;
detecting occurrences of loss of signal;
detecting occurrences of link resets or failures; and/or
detecting recent occurrences of CRC errors.

26. In a computer system having a graphical user interface including a display, a data processing device, and a user interface, a method of displaying a topology describing a storage area network (SAN) comprising:
discovering devices and data paths within the SAN;
displaying device icons and connection icons of the SAN in the topology;
displaying the data paths within the SAN in the topology;
identifying occurrence of an event in the SAN; and
updating the topology when the event occurs.

27. A method according to claim 26, further comprising:
updating the topology when new devices are added to the SAN or devices of the SAN are shut down.

28. A method according to claim 26, further comprising:
receiving in-band network data from an in-band metric source, wherein the occurrence of the event in the SAN is identified by analyzing the in-band network data.

29. A method according to claim 26, further comprising:
receiving out-of-band information from a SAN device, wherein the occurrence of the event in the SAN is identified by analyzing the out-of-band information.

30. A method according to claim 26, further comprising:
displaying a history of connection alerts and/or events.

31. A method according to claim 26, further comprising detecting an existing data path that does not meet a template and displaying indicia that identifies the existing data path that does not meet the template on the topology.

32. A method according to claim 31, wherein the template includes threshold parameters that are created by a manufacturer or vender of a SAN device in the SAN.

33. A method according to claim 31, wherein the template includes threshold parameters that include performance, configuration, faults and/or reliability parameters.

34. A method according to claim 31, wherein the template includes a user defined threshold parameter.

35. A method according to claim 31, wherein the threshold includes a protocol parameter.

36. A method according to claim 31, further comprising:
receiving an in-band metric;
analyzing the in-band metrics to identify a protocol error; and
displaying the protocol error on the topology.

37. A method according to claim 31, further comprising:
displaying an attribute of a SAN device on the topology.

38. A method according to claim 37, wherein the attribute includes a performance, fault, and/or configuration attribute of the SAN device.

39. A policy based data path analyzer comprising:
an out-of-band interface configured to receive out-of-band information from a storage area network (SAN) device in a SAN describing a SAN device type to which the SAN device belongs and a performance characteristic of the SAN device;
a data processing device configured to execute instructions stored on a computer readable medium;
a computer readable medium comprising executable instructions that cause the data processing device to perform the following functions when executed:
create a model of the SAN to identify relationships between SAN devices within the SAN based on the out-of-band information received; and
analyze the out-of-band information received to identify a vulnerability in the SAN.

40. A policy based data path analyzer according to claim 39, wherein the policy based data path analyzer further comprises an in-band interface configured to receive in-band data from an in-band metrics source, the computer readable medium comprising executable instructions that cause the data processing device to analyze the in-band network data received to identify a vulnerability in the SAN.

41. A policy based data path analyzer according to claim 39, further comprising an in-band metric source, the in-band metric source including the in-band interface configured to extract data from a link in the SAN transferring data between two SAN devices.

42. A policy based data path analyzer according to claim 39 further comprising a display, wherein the computer readable medium comprising executable instructions that cause the data processing device to generate and display a topology of the network along with an indication of the vulnerability identified.

43. A policy based data path analyzer according to claim 39, wherein the computer readable medium further comprises executable instructions that cause the data processing device to parameterize a set of attributes for a desired data path between a process and a storage device of the SAN, and construct the data path that provides said set of attributes.
